(19) United States
(12) Patent Application Publication
(10) Pub. No.: US 2014/0290632 A1
(43) Pub. Date: Oct. 2, 2014

(54) Intake Gas Distribution Box For Use In An Engine, In Particular A Motor Vehicle Engine, And Gas Supply Module Comprising Said Box

(71) Applicants: Georges De Pelsemaeker, Poigny-la-Foret (FR); Jean-Pierre Galland, Les Essarts-le-Roi (FR); Laurent Odillard, Le Luart (FR)

(72) Inventors: Georges De Pelsemaeker, Poigny-la-Foret (FR); Jean-Pierre Galland, Les Essarts-le-Roi (FR); Laurent Odillard, Le Luart (FR)

(21) Appl. No.: 14/008,599

(22) PCT Filed: Feb. 13, 2012
(86) PCT No.: PCT/EP2012/052389

§ 371 Date: Jun. 12, 2014

(30) Foreign Application Priority Data
Mar. 31, 2011 (FR) 1152695

(51) Int. Cl. F02M 25/07

(52) U.S. Cl. CPC F02M 25/0752
USPC 123/568.13

(57) ABSTRACT

An intake gas distribution box (18) for an engine is intended to equip a gas supply module of the engine. The box (18) comprises a recirculated exhaust gas injection device (24) for the engine. The box (18) is configured to be mounted on a cylinder head of the engine. The recirculated exhaust gas injection device (24) comprises a plurality of injection orifices (26.1, 26.2, 26.3, 26.4), formed in a portion of material of the recirculated exhaust gas injection device (24). The injection device (24) is configured so that the injection orifices (26.1, 26.2, 26.3, 26.4) are situated in a substantially medium area between the cylinder head of the engine and a heat exchanger (16) of the gas supply module. The engine can be a diesel engine.

The invention relates to an intake gas distribution box in an engine, notably a motor vehicle engine, and a gas supply module for said engine, comprising said box.

An intake gas supply module for a vehicle engine makes it possible to provide a mixture, called intake gas, including air, for the operation of the engine.

Such an intake gas supply module comprises a heat exchanger for cooling the air and a distribution box for collecting the cooled air and distributing it, via a cylinder head, to the cylinders of the engine.

Intake gas supply modules are known that also comprise a valve for injecting a portion of the exhaust gases from the engine, called recirculated exhaust gases, into the distribution box.

Such a distribution box thus makes it possible to distribute to the cylinders of the engine a mixture of cooled air originating from the heat exchanger and of recirculated exhaust gases originating from the valve. To this end, the distribution box comprises a cavity defining a space in which the cooled air and the recirculated exhaust gases are mixed.

In order to inject the recirculated exhaust gases into this space, the distribution box comprises a substantially cylindrical injection channel pierced by a plurality of injection orifices.

A distribution box is known in which the injection orifices are arranged linearly along the injection channel, the intake of the gas into the injection channel being done, via the valve, by one of the ends of the injection channel.

In the context of the invention, analysis has shown that many phenomena need to be taken into account to favor optimum operation of the engine, such as the uniformity of the cooled air-recirculated exhaust gas mixture, distributed to each of the cylinders, as well as clogging and the risks of corrosion due to the particulates and components present in the exhaust gases. It has in particular been discovered that these two phenomena evolved inversely as a function of the distance between the recirculated exhaust gas injection orifices and the heat exchanger.

The aim of the invention is to exploit these observations and said invention relates to an intake gas distribution box in an engine, notably a diesel engine, said box being intended to equip a gas supply module of said engine, said box comprising a recirculated exhaust gas injection device for said engine, the box being configured to be mounted on a cylinder head of the engine, said injection device comprising a plurality of injection orifices formed in a portion of material of the injection device, the box being characterized in that the injection device is configured so that the injection orifices are situated in a substantially median area between the cylinder head and a heat exchanger of the supply module.

This notably makes it possible to obtain an optimal trade-off between the reduction of the clogging of the injection device by the recirculated exhaust gases and the intermingling of the recirculated exhaust gases and of the cooled air originating from the heat exchanger. It is thus possible to ensure that the recirculated exhaust gas rate is substantially uniform from one cylinder to another while protecting the box against premature wear.

Preferably, an opening of the box on the cylinder head and an opening of the box on the heat exchanger respectively define two planes, called interface planes, and each orifice is situated at a substantially equal distance from these two planes.

According to one aspect of the invention, the orifices are arranged linearly along the injection device so as to be located at a substantially equal distance between the cylinder head and the head exchanger. It will be understood from that that said orifices are situated closer to the median area of the box than the interface planes.

According to a first variant, the injection orifices are configured so that the injection of the recirculated exhaust gases is oriented toward the cylinder head. They will then be situated, for example, between the median area of the box and the interface plane with the exchanger.

Thus, according to one feature of the invention, the distribution box is configured so that the angle, between the direction of flow of the intake gases originating from the heat exchanger and directed toward the cylinder head and the direction of injection of the recirculated exhaust gases, is between 0 and 80 degrees.

According to a second variant, the injection orifices are configured so that the injection of the recirculated exhaust gases is oriented toward the heat exchanger. They will then be situated, for example, between the median area of the box and the interface plane with the cylinder head.

Thus, according to one feature of the invention, the distribution box is configured so that the angle, between the direction of flow of the intake gases originating from the heat exchanger and directed toward the cylinder head and the direction of injection of the recirculated exhaust gases, is between 100 and 180 degrees.

Said distribution box will also be able to include a space suitable for allowing the mixing of a received air flow, notably from the heat exchanger, and of the recirculated exhaust gases injected by the injection device into said space.

The invention also relates to an intake gas supply module of a vehicle engine, notably a diesel engine, said module comprising a heat exchanger for said intake gases and a distribution box as defined above, the module being configured to allow the injection of the recirculated exhaust gases into said intake gases downstream of the heat exchanger depending on the direction of flow of the intake gases in the module.

Other features and advantages of the invention will become apparent from the following description given in light of the attached figures which are given as nonlimiting examples, identical references being given to similar objects, in which:

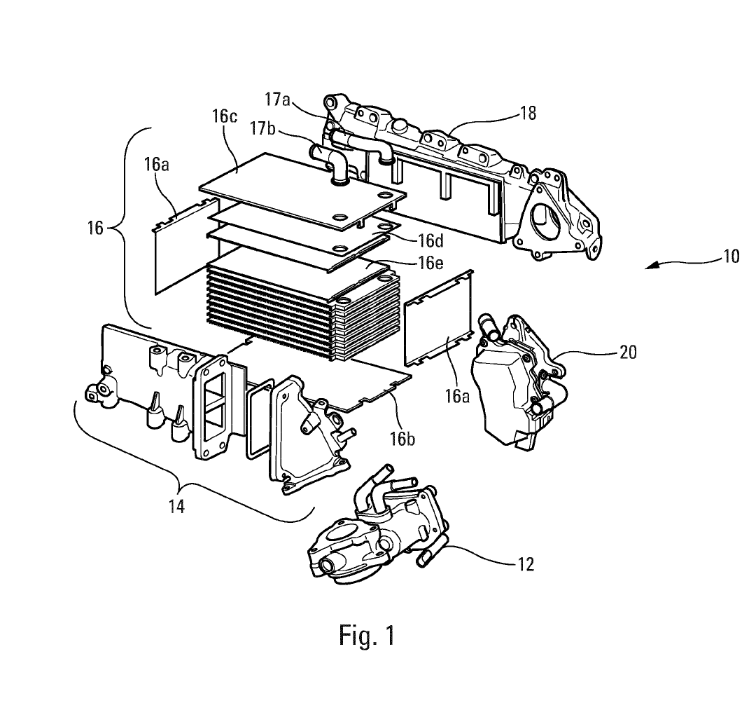

FIG. 1 is an exploded view, in perspective, of an intake gas supply module of a vehicle engine, according to the invention.

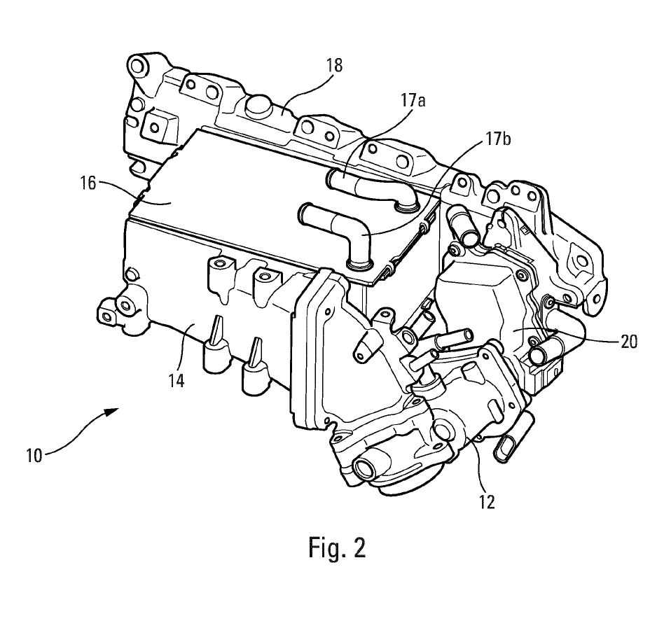

FIG. 2 illustrates, in perspective, the supply module of FIG. 1 assembled.

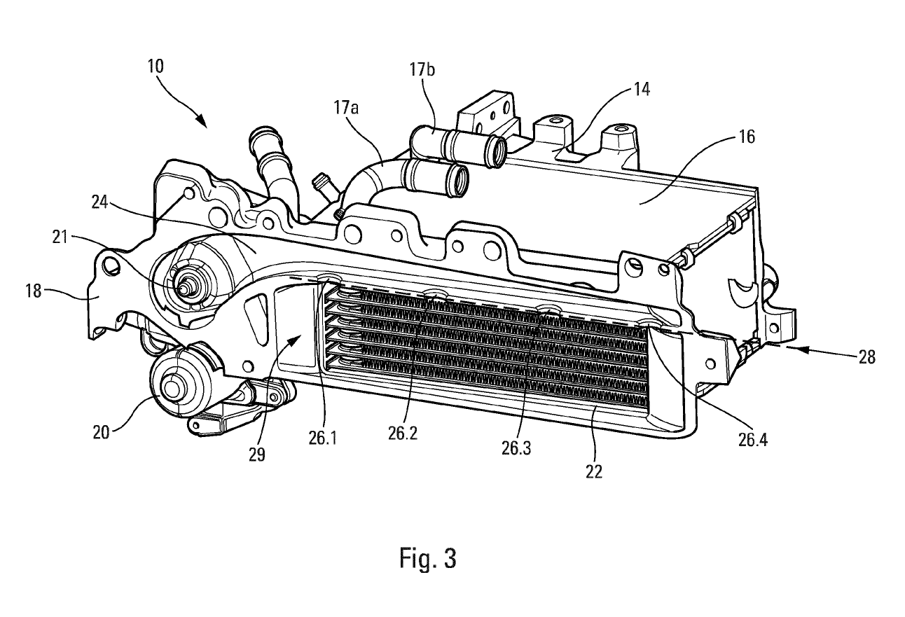

FIG. 3 is a perspective view of a distribution box of an intake gas supply module, according to the invention, illustrated in cross section.

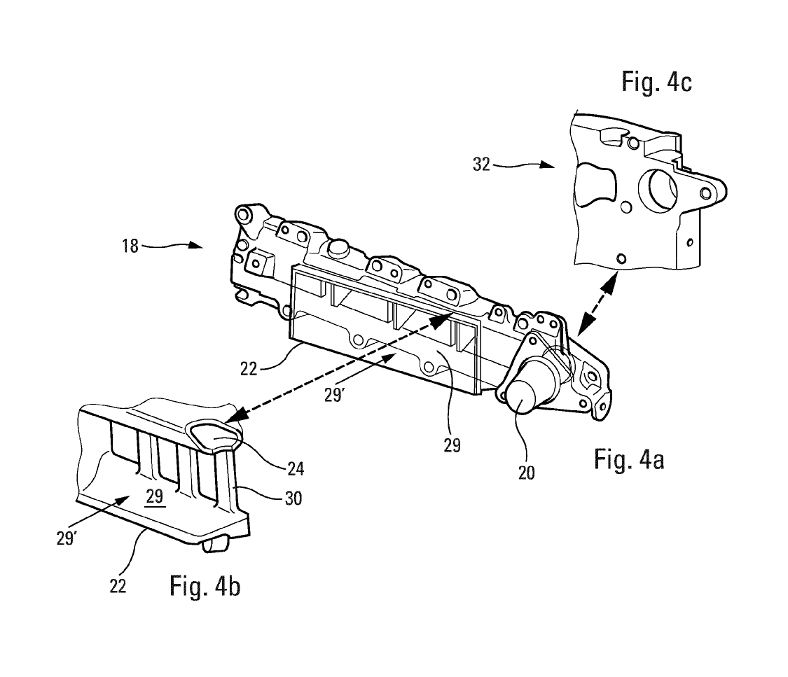

FIG. 4a shows, in perspective, an intake gas supply module distribution box, according to the invention.

FIG. 4b is a partial view, in perspective, of an intake gas supply module distribution box, according to the invention, illustrated in cross section so as to show the interior of its injection channel.

FIG. 4c is a partial view of a cylinder head of a vehicle engine, on which the box of FIG. 4a is intended to be mounted.

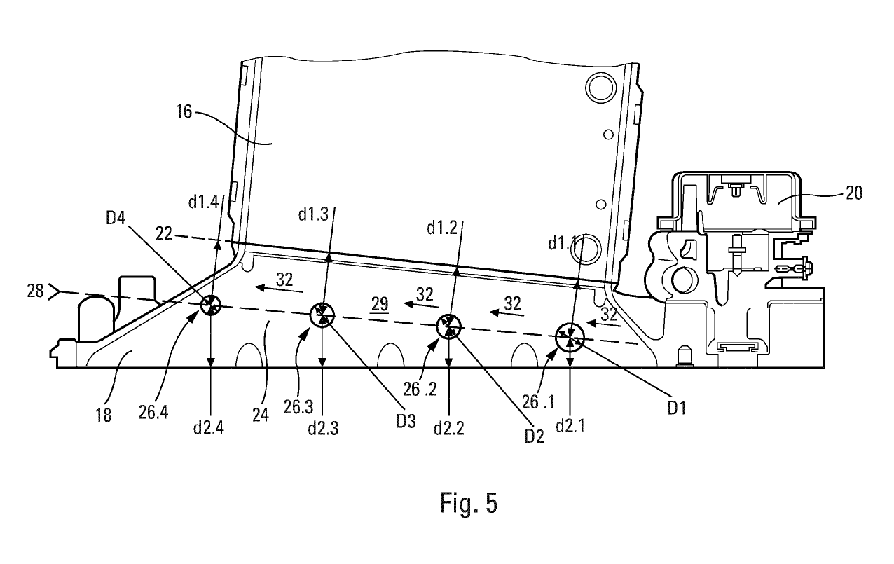

FIG. 5 is a partial view from below of an injection channel of a distribution box according to the invention, illustrated in cross section in order to show said channel.

FIGS. 1 to 5 show different elements of an intake gas supply module of a vehicle engine.

The intake gas supply module 10 of a vehicle engine illustrated in FIG. 1 comprises a collector box 14 supplying a heat exchanger 16 with a fluid, for example air from an engine supercharging circuit. The intake gas supply module 10 may also comprise a valve 12 for controlling the fluid flow rate.

The heat exchanger 16 comprises, for example, lateral walls 16a, a bottom wall 16b and a top wall 16c between which are stacked plates 16d and internal separators 16e. The top wall 16c comprises inlet/outlet nozzles 17a, 17b for a coolant for the fluid. The plates 16d are assembled in pairs to form, between two plates of one and the same pair, first coolant circulation channels and, between two plates situated facing two neighboring pairs, fluid circulation channels, provided with said separators 16e. The fluid thus circulates through the valve 12, then the collector box 14 and finally through the internal separators 16e.

The intake gas supply module 10 comprises a distribution box 18 with which to distribute or guide the fluid, which has been cooled by the heat exchanger 16, to the cylinders of the engine of the vehicle.

The intake gas supply module 10 illustrated also comprises a valve 20 for introducing a portion of the exhaust gases from the engine, called recirculated exhaust gases, into the distribution box 18. The valve 20 is called EGR (Exhaust Gas Recirculation) valve.

FIG. 2 illustrates the intake gas supply module 10 of FIG. 1 assembled. The valve 12 for controlling the fluid flow rates supplying the module is thus mounted on the fluid collector box 14. The collector box 14 is mounted on one the two faces without a wall of the heat exchanger 16 in order to allow the passage of the fluid toward the exchanger. The distribution box 18 is mounted on the other face without a wall of the heat exchanger 16 in order to collect the fluid cooled by the heat exchanger 16, and mix it with the recirculated exhaust gases and distribute the duly obtained mixture to the cylinders of the engine. The EGR valve 20 is mounted on the distribution box 18.

As illustrated by FIG. 3, the EGR valve 20 allows a passage for the recirculated exhaust gases through an inlet orifice 21 of an injection device 24 of the distribution box 18. Such an injection device 24 according to the invention comprises a plurality of injection orifices, or injectors 26.1, 26.2, 26.3, 26.4. The device illustrated takes the form of a tapered channel. However, any equivalent form could suit the person skilled in the art in order to produce the present invention.

Preferably, but in a nonlimiting manner, the injection orifices 26.1, 26.2, 26.3, 26.4, are arranged linearly along an axis 28 passing through them at their respective centers. They are arranged so as to be located facing engine intake gas supply orifices. As a variant, each orifice is divided into two.

In the illustration of FIG. 3, the injection channel 24 is of elongate form and plugged at the end opposite to the entry of the recirculated exhaust gases through the inlet orifice 21.

The distribution box 18 comprises a cavity defining, with an opening 22 at the junction with the heat exchanger 16, a space 29 in which the cooled air originating from the heat exchanger 16 and the recirculated exhaust gases, originating via the injection channel 24 of the distribution module 18, from the EGR valve 20, are mixed. The channel 24 is, notably, derived from material of a body of the box 18, defining said space 29.

FIG. 4a illustrates the space 29. The arrow 29′ indicates the direction, substantially at right angles to the interface plane defined by the opening 22 of the box 18 on the heat exchanger 16, and the direction of the flow of cooled fluid leaving the heat exchanger 16 through the opening 22 and passing through the space 29 of the distribution box 18 toward the cylinder head 32. In this FIG. 4a, for the purposes of clarity, the EGR valve 20 is represented only partially.

The injection channel 24, illustrated by FIG. 4b, of the distribution box 18, makes it possible to inject the recirculated exhaust gases originating from the EGR valve 20 into the space 29 via the injection orifices 26.1, 26.2, 26.3, 26.4, opening out substantially at right angles to the flow of cooled fluid coming from the heat exchanger 16.

The mixture, obtained in the space 29, between the cooled fluid originating from the heat exchanger 16 and the injected recirculated exhaust gases is then distributed or guided by guiding means 30 of the distribution box 18 toward the intake gas supply orifices of the cylinders of the engine via its cylinder head 32.

As illustrated by FIG. 4c, the distribution box 18 and the cylinder head 32 of the engine are intended to be mounted one on top of the other.

One embodiment proposes that the heat exchanger 16, the opening 22 of the distribution box 18 and the cylinder head 32 of the engine should be arranged substantially on one and the same axis. In other words, in this embodiment, the heat exchanger 16, the opening 22 of the distribution box 18 and the cylinder head 32 of the engine are substantially aligned.

FIG. 5 illustrates an injection channel 24 here comprising four orifices 26.1, 26.2, 26.3 and 26.4 arranged linearly along an axis 28 passing through the center of each orifice. They will be able to be more or less than four of them. In particular, as already indicated, they will be able to be grouped in pairs, each pair being arranged so as to be located facing the intake gas supply orifices provided in the cylinder head of the engine.

The recirculated exhaust gases originating from the valve 20 via the inlet orifice 21 circulate in the injection channel 24 substantially in the direction of the arrows 32 toward the orifices 26.1, 26.2, 26.3 and 26.4.

It will be noted that the injection orifices illustrated are circular, but could perfectly well be rectangular or of any other form, such as, for example, a slot. Moreover, in the case of orifices grouped in pairs, as indicated above, the orifices of one and the same pair will be able to be identical.

The diameters D1, D2, D3, D4 respectively of the orifices 26.1, 26.2, 26.3, 26.4 can be between 8 and 20 mm. They can, for example, be of decreasing size from the inlet 21 of the channel 24. The injection channel, for its part, can be, for example, tapered with a section between, for example, 20 and 28 mm.

The ratio between the surface area of the largest injection orifice and the surface area of the smallest injection orifice can be, for example, between 1.4 and 2.25. Also, the ratio of their diameter relative to the diameter of the distribution duct can be, for example, between 0.1 and 0.4.

The distance d1.1, d1.2, d1.3, d1.4 represents the distance between the center, respectively, of the orifices 26.1, 26.2, 26.3, 26.4 and the opening 22. In other words, d1.1, d1.2, d1.3, d1.4 is the distance which separates the plane comprising the opening 22 and the parallel plane comprising the axis 28 for each orifice 26.1, 26.2, 26.3, 26.4. This distance can, for example, be between 32 and 36 mm. For example, it increases from one orifice to another from the inlet 21 of the channel 24, in the case of an intake module with a biased orientation relative to the cylinder head.

The distance d2.1, d2.2, d2.3, d2.4 represents the distance between the center of the orifices 26.1, 26.2, 26.3, 26.4 and an opening on the cylinder head 32. This distance can, for example, be between 15 and 33 mm. For example, it increases from one orifice to another from the inlet 21 of the channel 24, in the case of an intake module with a biased orientation relative to the cylinder head.

According to the invention, the orifices are situated in a median area between the interface plane defined by the opening of the box on the cylinder head and the interface plane defined by the opening of the box on the heat exchanger. Thus, the distances d1 and d2 are substantially equal or similar so that the orifices are substantially equidistant from the cylinder head and from the heat exchanger. A trade-off is thus obtained between the clogging of the distribution box by the recirculated exhaust gases and obtaining a satisfactory cooled air/recirculated exhaust gas mixture.

With such a configuration of the orifices, it is also possible to reduce the risks of explosion of the heat exchanger 16 induced by the high pressure of the recirculated exhaust gases coming from the valve 20.

As illustrated, the axis 28 passing through the center of each orifice 26.1, 26.2, 26.3, 26.4 forms, for example, a bisector of the angle formed by the planes of the opening 22 on the exchanger and of the opening on the cylinder head 32.

The distances d1.1+d2.1, d1.2+d2.2, d1.3+d2.3, d1.4+d2.4 between the opening 22 and the cylinder head 32 can be between, for example, 47 and 69 mm, thus making it possible to avoid flame returns from the cylinders to the heat exchanger 16.

They increase from one orifice to another from the inlet 21 of the channel 24 in the case of an intake module with a biased orientation relative to the cylinder head.

The direction of injection of recirculated exhaust gases through the orifices 26.1, 26.2, 26.3, 26.4 can be at right angles to the direction of flow, or to the flow, of the intake gases originating from the heat exchanger 16 and directed toward the cylinder head 32.

Alternatively, the direction of injection of recirculated exhaust gases through the orifices 26.1, 26.2, 26.3, 26.4 can form an angle, with the direction of flow of the intake gases originating from the heat exchange 16 and directed toward the cylinder head 32, of between 0 and 80 degrees. The orientation of the recirculated exhaust gases toward the cylinder head 32 notably makes it possible to reduce the clogging of the injection channel 24 by the recirculated exhaust gases which are directed more directly and rapidly toward the cylinder head 32. In this configuration, the injection orifices are situated, for example, in the half of the median area of the distribution box 18 situated on the side of the heat exchanger 16.

Alternatively, the direction of injection of recirculated exhaust gases through the orifices 26.1, 26.2, 26.3, 26.4 can form an angle, with the direction of flow of the intake gases originating from the heat exchanger 16 and directed toward the cylinder head 32, of between 100 and 180 degrees. The injection orifices are thus configured so that the injection of the recirculated exhaust gases is oriented toward the heat exchanger 16. This orientation of the recirculated exhaust gases toward the heat exchanger 16 notably allows for a better mixing, in the distribution box 18, of the injected recirculated exhaust gases with the cooled air originating from the heat exchanger 16. In this configuration, the injection orifices are situated, for example, in the half of the median area of the distribution box 18 situated on the side of the cylinder head 32.

Obviously, some of the orifices of one and the same injection channel 24 may be oriented so that an angle is formed, that is to say with a direction of injection oriented toward the cylinder head, and other orifices of the same injection channel 24 may be oriented so that the direction of injection is at right angles, or oriented in an opposite manner, relative to the direction of flow of the intake gases originating from the heat exchanger 16 and directed toward the cylinder head 32.

1. An intake gas distribution box for an engine, said box being intended to equip a gas supply module of the engine, said box comprising a recirculated exhaust gas injection device for the engine, said box being configured to be mounted on a cylinder head of the engine, said recirculated exhaust gas injection device comprising a plurality of injection orifices formed in a portion of material of said recirculated exhaust gas injection device, wherein said recirculated exhaust gas injection device of said box is configured so that said injection orifices are situated in a substantially median area between the cylinder head and a heat exchanger of the gas supply module.

2. The box as claimed in claim 1, in which an opening of said box on the cylinder head and an opening of said box on the heat exchanger respectively define two planes (interface planes), and each injection orifice is situated at a substantially equal distance from these two planes.

3. The box as claimed in claim 1, in which said injection orifices are arranged linearly along said recirculated exhaust gas injection device so as to be located at a substantially equal distance between the cylinder head and the heat exchanger.

4. The box as claimed in claim 1, in which said injection orifices are configured so that the injection of recirculated exhaust gases is oriented toward the cylinder head.

5. The box as claimed in claim 1, said box being configured so that an angle, defined between i) the direction of flow of intake gases originating from the heat exchanger and directed toward the cylinder head and ii) the direction of injection of recirculated exhaust gases, is between 0 and 80 degrees.

6. The box as claimed in claim 1, in which said injection orifices are configured so that injection of recirculated exhaust gases is oriented toward the heat exchanger.

7. The box as claimed in one claim 1, said box being configured so that an angle, defined between i) the direction of flow of intake gases originating from the heat exchanger and directed toward the cylinder head and ii) the direction of injection of recirculated exhaust gases, is between 100 and 180 degrees.

8. The box as claimed in claim 1, also comprising a space suitable for mixing of received air flow from the heat exchanger (16), and of recirculated exhaust gases injected by said recirculated exhaust gas injection device into said space.

9. An intake gas supply module for a vehicle engine said module comprising a heat exchanger for intake gases and said box as claimed in claim 1, said module being configured to allow injection of recirculated exhaust gases into intake gases downstream of said heat exchanger depending on the direction of flow of intake gases in said module.

10. The box as claimed in claim 2, in which said injection orifices are arranged linearly along said recirculated exhaust gas injection device so as to be located at a substantially equal distance between the cylinder head and the heat exchanger.

11. The box as claimed in claim 1, wherein the engine is a diesel engine.

12. The module as claimed in claim 9, in which an opening of said box on the cylinder head and an opening of said box on the heat exchanger respectively define two planes (interface planes), and each injection orifice is situated at a substantially equal distance from these two planes.

13. The module as claimed in claim 12, in which said injection orifices are arranged linearly along said recirculated exhaust gas injection device so as to be located at a substantially equal distance between the cylinder head and the heat exchanger.

14. The module as claimed in claim 9, in which said injection orifices are arranged linearly along said recirculated exhaust gas injection device so as to be located at a substantially equal distance between the cylinder head and the heat exchanger.

15. The module as claimed in claim 9, wherein the vehicle engine is a diesel engine.
